(19) United States
(12) Patent Application Publication
(10) Pub. No.: US 2022/0392675 A1
(43) Pub. Date: Dec. 8, 2022

(54) MAGNETIC MATERIALS AND MANUFACTURING

(71) Applicant: CM Materials Inc., Wilmington, DE (US)

(72) Inventor: Md Aminul Mehedi, Wynnewood, PA (US)

(21) Appl. No.: 17/825,729

(22) Filed: May 26, 2022

Related U.S. Application Data
(60) Provisional application No. 63/195,256, filed on Jun. 1, 2021.
(60) Provisional application No. 63/195,255, filed on Jun. 1, 2021.

(51) Int. Cl. H01F 1/147; C01B 21/06; C01B 21/082; H01F 1/20

(52) U.S. Cl. CPC H01F 1/147; C01B 21/0622; C01B 21/0828; H01F 1/20; C01P 2006/42; C01P 2002/77; C01P 2002/72; C01P 2002/85; C01P 2004/03

(57) ABSTRACT

Soft magnetic materials, and related techniques for manufacturing such soft magnetic materials, are disclosed herein. Such magnetic materials can be based on iron nitride, iron oxynitride, iron boronitride and/or iron carbonitiride. The techniques disclosed herein for manufacturing ferromagnetic particles can be used to control functional magnetic and electrical properties of the manufactured particles. Some techniques disclosed herein can be used to form a coating on a particle, with the coating having a thickness of 0.05 to 1.00 μm. These magnetic materials manufactured via one or more of the techniques disclosed herein can have both relatively high magnetic induction and relatively high electrical resistivity.

### RELATED APPLICATIONS

This application claims priority to each of U.S. provisional patent application No. 63/195,255, filed on Jun. 1, 2021, and U.S. provisional patent application No. 63/195,256, filed on Jun. 1, 2021, the disclose of each such provisional application being hereby incorporated by reference.

### TECHNICAL FIELD

This disclosure generally relates to magnetic materials (e.g., soft powder magnetic materials) manufacturing and related techniques, compounds, and devices. These magnetic materials can, for example, be synthesized for electromagnetic devices. As specific examples, magnetic materials disclosed herein can be used for power electronics, actuators, transducers, and sensor applications, as illustrative, non-limiting examples.

### BACKGROUND

Soft magnetic materials are used for electromagnetic applications such as motors, generators, inductors, EMI filters, transformers, transducers, actuators, and sensors. In general, currently available soft magnetic materials do not provide both high magnetic induction and high resistivity. High induction magnetic material tends to be used for smaller and lighter components, devices, and machines, and different magnetic material, with high resistivity, tends to be used for low core loss and more efficient electronic components, devices, and machines.

Soft Magnetic materials can be made into different forms such as powder, coil/strip, bar, nanoparticle, and thin film. The different forms of materials are used for different applications. For example, a soft magnetic thin film such as permalloy (FeNi alloy) is used for EMI filter in RF devices. Another example would be the use of Fe₂O₃ and Fe₃O₄ particles for biomedical devices and cancer treatment. Soft magnetic coils and strips such as Iron Silicon (also known as silicon steel) and Iron-Cobalt are commonly used in motors, generators, actuators, and sensors. The powder of Iron, MnZn Ferrite (MnₓZn₁₋ₓ.Fe₂O₄), NiZn Ferrite (MnZn Ferrite (NiₓZn₁₋ₓ.Fe₂O₄), Iron Silicon, and Amorphous soft magnets can be used as powder cores. Powder cores can be used as inductors, chokes, actuators, and EMI filters for power management and power conversion applications. Additionally, Nanocrystalline and Amorphous strips are used as magnetic cores in transformers, EMI chokes, RF filters, inductors, and inductive components.

Magnetic induction and resistivity are both material properties that are attained through the specialized composition of the ferromagnetic materials, controlled spin-orbit coupling, controlled spin magnetic moments, and density of states of the magnetic compositions.

Currently available soft magnetic compositions demonstrate one of three ranges of properties—a) high induction and low resistivity, b) medium induction and medium resistivity, or c) low induction and high resistivity. Material such as Iron demonstrates high induction and low resistivity. Alloys such as Iron Nickel (permalloy), Sendust (FeSiAl), Nanocrystalline, and Amorphous soft magnets demonstrate medium induction and medium resistivity. Compounds such as MnZn Ferrite and NiZn Ferrite show low induction and high resistivity.

Magnetic induction and resistivity are important to control the electronic device size and efficiency. Higher induction can help to reduce the electronic device size. Higher resistivity can help to reduce magnetic core loss and improve efficiency of electronic devices.

### SUMMARY

In the electromagnetic industry, it would be useful to have a synthesized magnetic material with both high magnetic induction and high resistivity. However, currently available soft magnetic materials do not provide both high magnetic induction and high resistivity. This limits the efficiency and size of the electronic components such as inductors, EMI filters, chokes, transformers, motors, actuators, transducers, motors, and generators. Iron and Iron Silicon-based materials tend to be used below 1 kHz applications because of the low electrical resistivity of the materials. Iron-Nickel, Sendust (FeSiAl), Amorphous and Nanocrystalline powder, and strip materials tend to be used between 1 kHz and 500 kHz because of their higher resistivity. However, these have lower magnetic induction relative to Iron and Iron Silicon but do possess higher resistivity, which facilitates a lower magnetic core loss. There is another class of materials called Soft Ferrites (MnZn Ferrite, NiZn Ferrite), which have low magnetic induction but possess high resistivity. The Soft Ferrite based electronic components have low magnetic core loss at a higher frequency, such as 1 kHz to 1 GHz. However, Soft Ferrites have very low magnetic induction, which results in increased device size and also passively influences reduced efficiency by necessitating more cooling, copper wires, and many more system-level disadvantages.

As detailed in the present disclosure, one or more coatings applied on magnetic powder alloy particles can be useful in insulating these particles from electrical interaction. Typically, for magnetic powder particles, the eddy current, or the secondary current, can flow from one particle to another. But, the electrical insulation layer of the coating shell applied to the magnetic powder particle can reduce the flow of eddy current from one particle to another.

Notably, the one or more coatings applied to magnetic powder alloy particles as disclosed herein can reduce eddy current flow and, thereby, reduce magnetic core loss and increase the efficiency of magnetic cores made from these coated magnetic powder alloy particles.

As further detailed herein, magnetic cores can be made using coated ferromagnetic particles. For example, the coated ferromagnetic particles can be compressed and post-treated to form, for instance, in some embodiments, 85-98% dense magnetic cores for functional devices such as inductors, chokes, filters, transformers, and stators.

The disclosure describes examples of the synthesis and formation of magnetic material compounds and magnetic cores using one or more particular types of ferromagnetic material.

Exemplary embodiments are described relating to magnetic materials based on iron nitride, iron oxynitride, iron boronitride and/or iron carbonitride. This includes soft magnetic materials including the following exemplary embodiments: FeₓN_{y}, FeₓN_{y}C_{z}, FeₓN_{y}O_{z}, FeₓN_{y}B_{z}, FeₓN_{y}M_{z}, where (M=CO, BC) and x=0.5-95 (e.g., x=75-95) at %, y=1-30 (e.g., y=5-25) at %, z=0.5-20 (e.g., z=5-15) at %. In these exemplary embodiments, Fe denotes to Iron, N denotes to Nitrogen, C denotes to Carbon, B denotes to Boron and O denotes to Oxygen. Notably, these compound embodiments can provide both high magnetic induction, for instance, in some examples, 1.5-1.8 T (170-200 emu/g), and high electrical resistivity, for instance, in some examples, 220-400 μΩ-cm.

The present disclosure describes embodiments for the formation of exemplary magnetic material compounds and magnetic cores from any one or more of FeₓN_{y}, FeₓN_{y}C_{z}, FeₓN_{y}O_{z}, FeₓN-_{y}B_{z}, FeₓN_{y}M_{z}, where (M=CO, BC) and x=0.5-95 (e.g., x=75-95) at %, y=1-30 (e.g., y=5-25) at %, z=0.5-20 (e.g., z=5-15) at %.

One embodiment includes a compound having the formula: FeₓN_{y}, where x=0.5-95 at % wherein y=1-30 at %.

In a further embodiment of this compound, x=75-95 at %. And, in a still further embodiment of this compound, y=5-25 at %.

Another embodiment include a compound having the formula: FeₓN_{y}O_{z}, where x=0.5-95 at %, y=1-30 at %, and z=0.5-20 at %.

In a further embodiment of this compound, x=65-90 at %. And, in a further such embodiment of this compound, y=5-25 at %. And, in a still further such embodiment of this compound, z=5-10 at %.

An additional embodiment includes a compound having the formula: FeₓN_{y}C_{z}, where x=0.5-95 at %, y=1-30 at %, and z=0.5-20 at %.

In a further embodiment of this compound, x=65-90 at %. And, in a further such embodiment of this compound, y=5-25 at %. And, in a still further such embodiment of this compound, z=5-10 at %.

Another embodiment includes a magnetic core. This magnetic core embodiment includes a magnetic material and a coating. The magnetic material has a formula: FeₓN_{y}, where x=0.5-95 at % and y=1-30 at %. The coating is applied to the magnetic material to provide an electrical insulation layer.

In a further embodiment of this magnetic core, the coating includes a ferrimagnetic material that forms a coating over the magnetic material. In one such example, the ferrimagnetic material is selected from the group consisting of: Fe₂O₃; Fe₃O₄; MnₓZn₁₋ₓ.Fe₂O₄; and NiₓZn₁₋ₓ.Fe₂O₄. In some such cases, a thickness of the coating formed by the ferrimagnetic material ranges from 0.05-0.50 μm or from 0.05-1.00 μm.

In some embodiments of this magnetic core, for the magnetic material formula x=75-95 at % and y=5-25 at %.

In some embodiments of this magnetic core, the magnetic core further includes a slurry element selected from the group consisting of: sodium metasilicate; talc; kaolinite; MgO; silicone resin; SiO₂; Al₂O₃; and phosphate.

An additional embodiment includes a method. This method embodiment includes the steps of: providing ferromagnetic particles in a reactive chamber, and introducing one or more gases into the reactive chamber to synthesize a magnetic material having the formula: FeₓN_{y}, where x=75-95 at % and y=5-25 at %.

In further embodiment of this method, the one or more gases introduced into the reactive chamber are selected from the group consisting of: NH3, O2, H2, and CO. In some such examples, this method can further include the steps of: when the one or more gases are introduced into the reactive chamber, heating the ferromagnetic particles in a reactive chamber to a temperature of 400-750° C. for 6-24 hours; and mixing the ferromagnetic particles with the one or more gases introduced into the reactive chamber using metallic balls.

The details of one or more examples are set forth in the accompanying drawings and description below. Other features, objects, and advantages will be apparent from the drawings and description.

### BRIEF DESCRIPTION OF DRAWINGS

The following drawings are illustrative of particular embodiments of the present invention and, therefore, do not limit the scope of the invention. The drawings are intended for use in conjunction with the explanations in the following description. Embodiments of the invention will be described in conjunction with the appended drawings, wherein like reference characters denote like elements.

FIG. 1 is a schematic diagram of exemplary doping and/or co-doping of interstitial atoms such as Nitrogen, Carbon, Boron and oxygen.

FIG. 2 is a schematic diagram of forming a magnetic material, such as one or more of FeₓN_{y}, FeₓN_{y}C_{z}, FeₓN_{y}O_{z}, FeₓN_{y}B_{z}, FeₓN_{y}M_{z}, where (M=CO, BC) and x=0.5-95 (e.g., x=75-95) at %, y=1-30 (e.g., y=5-25) at %, z=0.5-20 (e.g., z=5-15) at % using an exemplary powder metallurgy and ball milling process.

FIG. 3 is a schematic diagram of forming a magnetic material, such as one or more of FeₓN_{y}, FeₓN_{y}C_{z}, FeₓN_{y}O_{z}, FeₓN_{y}B_{z}, FeₓN_{y}M_{z}, where (M=CO, BC) and x=0.5-95 (e.g., x=75-95) at %, y=1-30 (e.g., y=5-25) at %, z=0-20 (e.g., z=5-15) at % using an exemplary reactive gas based process.

FIG. 4 is a flow diagram of an exemplary process of building compounds and alloys using different components to provide a combination of magnetic characteristics, such as high induction, high resistivity, low core loss, controlled permeability, and/or low coercivity, along with other structural properties, such as appropriate mechanical strength, and/or appropriate corrosion resistance.

FIG. 5 is a plot showing resistivity and magnetic induction of various compounds, including an exemplary Fe₄₋ₓNₓ compound (“Iron Nitride”).

FIG. 6 shows a crystalline structure of the exemplary Fe₄₋ₓNₓ compound.

FIG. 7 is a flow diagram of an exemplary process of milling ferromagnetic powder particles.

FIG. 8 is a schematic diagram of the flow of the magnetic field and eddy current in an exemplary powder particle mix.

FIG. 9 is a schematic diagram of the coating of the particles.

FIG. 10 is a schematic diagram of using an exemplary powder metallurgy and ball milling process for the formation of a coating layer in the shell of the powder particle.

FIG. 11 is a flow diagram of an exemplary oxide treated particle coating and homogenization process.

FIG. 12 is an exemplary reactive gas-based oxide coating process in ferromagnetic powder particles.

FIG. 13 is an exemplary fluidized bed spray coating using a slurry of the ferrimagnetic or nonmagnetic mixture on the ferromagnetic powder particles.

FIG. 14 is an exemplary coating thickness variation illustration with different slurry concentrations.

FIG. 15 is an illustration of “blade” mixing via rotary propeller mixing.

FIG. 16 is an illustration of “RotoVap” process to evaporate solvent from slurry.

FIG. 17 is a table showing exemplary quantities for a coating mixture composition for building coating between 100-500 nm.

FIG. 18 a flow diagram of exemplary preparation of the powder slurry for building a magnetic core.

FIG. 19 is a flow diagram of exemplary preparation of powder slurry for building a magnetic core with an additional plasticizer to enable higher pressing force in compaction.

FIG. 20 is an exemplary mixing recipe for making a slurry that can be used in making a coated ferromagnetic particle.

FIG. 21 is a flow diagram of an exemplary process for forming a coating slurry and building a coated ferromagnetic particle.

FIG. 22 is a schematic diagram of exemplary compression of the powder particles to form a magnetic core.

FIG. 23 is a flow diagram of an exemplary process for compressing coated ferromagnetic particles where a second pressing (e.g., cold isostatic press die) is applied to further increase particle density for ultimately compacting the particles into a magnetic core.

FIG. 24 is a schematic diagram of an exemplary magnetic compaction technique using an electromagnet for directional compaction of powders into a magnetic core.

FIG. 25 is a schematic diagram of exemplary magnetic particles' size distribution for high-density compaction.

FIG. 26a is a demonstration of precursor Carbonyl Iron particles, and FIG. 26b is the XRD of partially nitrided Iron for example 2.

FIG. 27 is a demonstration of XRD of the nitrided Carbonyl Iron particles for example 3.

FIG. 28 is a demonstration of XRD of the nitrided Carbonyl Iron particles for example 4.

FIG. 29 is a demonstration of XRD of the nitrided Carbonyl Iron particles for example 5.

FIG. 30 is schematic demonstration of double shell one core structure with Iron oxide and Iron nitride shell with Iron core.

FIG. 31 is the of XRD of the oxynitrided core-shell structure for example 6.

FIG. 32 is the permeability of Iron oxide and Iron nitride, Fe₄₋ₓNₓ for example 6.

FIG. 33 is the permeability of Iron and Iron nitride, Fe₄₋ₓNₓ for example 7.

FIG. 34 is the SEM EDS map of MgO coated Iron nitride, Fe₄₋ₓNₓ particles for example 8.

FIG. 35 is the SEM EDS map of SiO₂ coated Iron nitride, Fe₄₋ₓNₓ particles for example 9.

FIG. 36 is the SEM EDS map of Phosphate coated Iron nitride, Fe₄₋ₓNₓ particles for example 10.

FIG. 37 is the permeability of Iron nitride, Fe₄₋ₓNₓ magnetic core for example 14.

FIG. 38 is the eddy current loss and hysteresis loss of Iron nitride, Fe₄₋ₓNₓ magnetic core for example 14.

FIG. 39 is the SEM EDS of Iron nitride, Fe₄₋ₓNₓ magnetic core for example 14.

FIG. 40 is the B-H hysteresis loop and magnetic flux density of Iron nitride, Fe₄₋ₓNₓ powder for example 15.

FIG. 41 is the ball milling process particle size engineering of Iron nitride, Fe₄₋ₓNₓ particles for example 18.

FIG. 42 is the XRD of the Fe-5 wt % Cr alloy produced via mechanical alloying for example 19.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of elements, materials, compositions, and/or steps are provided below. Though those skilled in the art will recognize that many of the noted examples have a variety of suitable alternatives that are also within the scope of the present disclosure.

As described herein, embodiments of the present disclosure include magnetic materials with both high resistivity and high magnetic induction. These embodiments can include soft magnetic materials with both high resistivity and high magnetic induction that can be used in electronic components, such as inductors, transformers, chokes, EMI filters, motors and generators, transducers, actuators, and sensors. The magnetic material embodiments disclosed herein can enable smaller and lighter magnetic cores that also have lower magnetic core loss, which, in turn, can help in reducing electronic component size, increase efficiency and make devices cooler.

Such embodiments can include ferromagnetic material, such as Iron (Fe), doped with interstitial atoms, such as Nitrogen, Carbon, Oxygen, and/or Boron to form FeₓN_{y}, FeₓN_{y}C_{z}, FeₓN_{y}O_{z}, FeₓN_{y}B_{z}, FeₓN_{y}M_{z}, where (M=CO, BC) and x=0.5-95 (e.g., x=75-95) atomic percent (at %), y=1-30 (e.g., y=5-25) at %, z=0.5-20 (e.g., z=5-15) at %. The inventor has discovered that interstitial dopants can increase the electrical resistivity of the base material, such as Iron (Fe).

This resulting increased resistivity of the doped base material can help to reduce associated magnetic core loss, thereby increasing efficiency associated with the doped base material.

Other ferromagnetic materials such as FeₓNi₁₋ₓ, FeₓCo₁₋ₓ, FeₓSi₁₋ₓ, and FeSiCuB can also be used instead of Fe as the base material to be doped with Nitrogen, Carbon, Oxygen, and/or Boron. For example, the solubility of the interstitial dopants Iron-based alloys can range from 0.02-5 wt % at elevated temperatures. Doping the noted base material with the interstitial atoms can reduce the magnetic core loss by increasing the electrical resistivity.

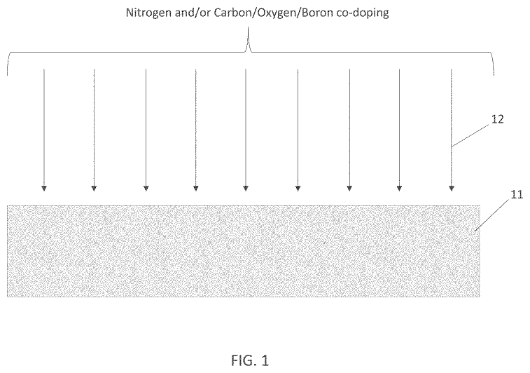

The interstitial doping can be performed via controlled heat treatment of the ferromagnetic powder materials in a reactive gas environment, such as Ammonia (NH₃), Hydrogen (H₂), Oxygen (O₂), and/or Carbon Monoxide (CO). FIG. 1 shows a schematic diagram of one exemplary embodiment of controlled doping of ferromagnetic powder 11 (e.g., Fe, FeₓNi₁₋ₓ, FeₓCo₁₋ₓ, FeₓSi₁₋ₓ, or FeSiCuB). A controlled concentration of nitrogen, Carbon, Oxygen, and/or Boron flow 12 can be passed through reactive gases delivered to the ferromagnetic powder 11 from one or more gas sources.

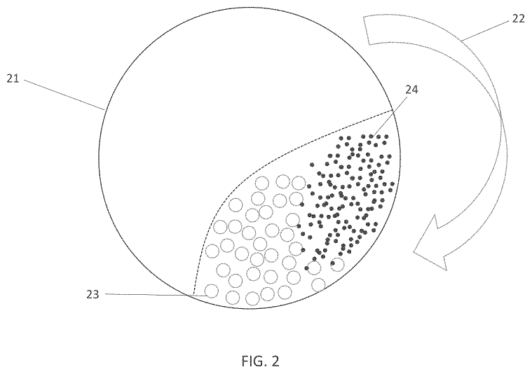

The ferromagnetic powder particles can be mixed in a planetary ball milling system 21, such as that shown in FIG. 2. The ferromagnetic particles 24 and steel (e.g., stainless steel) balls 23 can be placed into the milling system 21, and the ferromagnetic particles 34 can be milled by mixing the ferromagnetic particles 24 with the steel balls 23, such as via rotation of the system 21, such as in a rotational direction 22, at a rate of, for example, 200-2000 rpm. The rotation of the system vessel can help to mix and reduce the size of the particles 24 and can also help to clean off any satellites in the particles 24. In some cases, ferromagnetic components, such as Fe, Ni, and/or Co, can be mixed with another alloying component, for instance, such as Cr, Mn, and Zn, to synthesize an alloy by mechanical mixing. The process can be referred to as mechanical alloying.

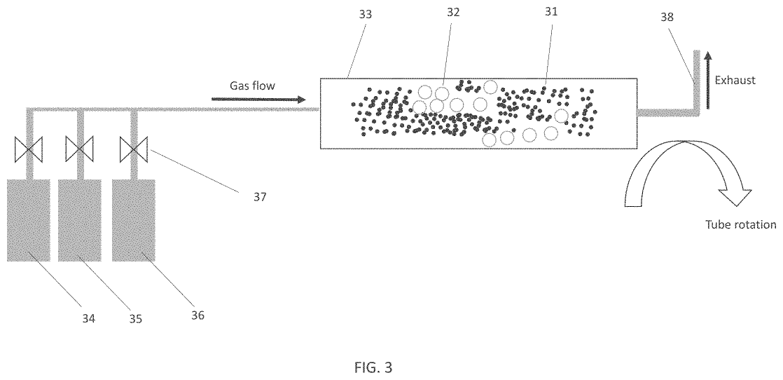

Synthesis of the interstitial doped ferromagnetic materials can be produced, for example, using a reactive gas-based reactor processor 33. FIG. 3 shows a schematic diagram of forming an interstitial doped ferromagnetic material (e.g., FeₓN_{y}, where x=0.5-90 at %, y=1-30 at %) using an exemplary gas-phase nitriding process. The reactor vessel can be made from quartz in tube form of, for instance, 1 to 2 inch in diameter. The reactor vessel can be rotated at 0-10 rpm using a motor on both ends. The rotation of particles helps in homogenizing the chemical reaction. The powder particles 31 can be placed inside the tube vessel, which is fluidly connected to a gas flow line, conveying one or more gases from one or more gas sources, and to exhaust line 38. The powder particles can be milled with zirconia or ceramic balls 32. The gas flow can be controlled via one or more flow meters and regulators 37. In the illustrated example, four gas tanks are used, as the gas sources, for nitriding the Iron and Iron-based alloys, such as Ammonia-NH₃ 34, Nitrogen-N₂ 35, and Hydrogen-H₂ 36. The controlled gas flow toward the reactor can determine the final composition of the ferromagnetic particles.

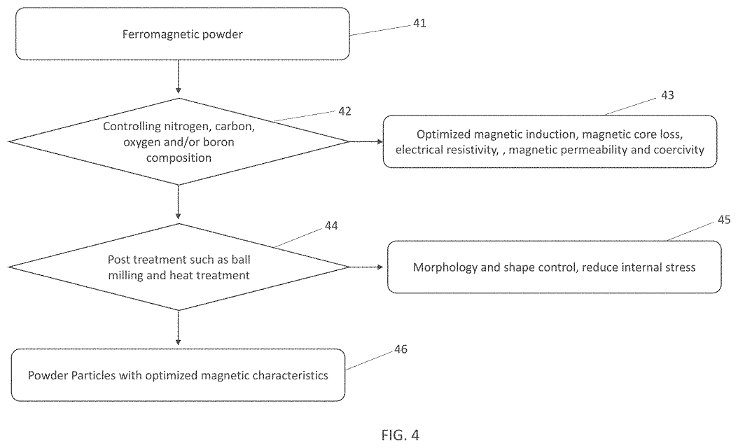

FIG. 4 shows a flow diagram of an exemplary process of building compounds and alloys using different components to provide a combination of magnetic characteristics, such as high induction, high resistivity, low core loss, controlled permeability, and/or low coercivity, along with other structural properties, such as appropriate mechanical strength, and/or appropriate corrosion resistance. For example, FIG. 4 can provide a process that can optimize the magnetic material's functional performance. Ferromagnetic powder is provided at step 41, and, at step 42, the provided ferromagnetic power can be doped with nitrogen, carbon, oxygen, and/or boron in a controlled manner. At step 43, the resulting doped ferromagnetic powder can have optimized magnetic material properties. Such optimized magnetic properties can include one or more of high magnetic induction, low core loss, high resistivity, and improved permeability and coercivity. At step 44, the doped ferromagnetic powder can be post-treated with ball milling, acid etching, and/or tempering at a temperature between, for instance, 200 and 450° C. for 2-3 hours to result, at step 45, in an increase in one or more of the functional performance properties. At step 46, the powder particles' morphology, internal stress, and shape can be controlled and optimized through the post-treatment performed at step 44.

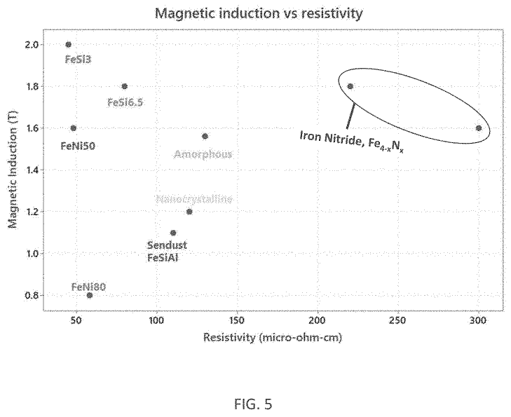

FIG. 5 is a plot showing the resistivity (x-axis) versus magnetic induction (y-axis) of various compounds. As shown in this plot, a Fe₄₋ₓNₓ compound (“Iron Nitride”) has both greater resistivity, and greater magnetic induction than each of the other materials on the plot—a Fe₄₋ₓ Nₓ compound (“Iron Nitride”) has both greater resistivity and greater magnetic induction than each of FeSi3, FeSi6.5, FeNi50, Amorphous, Nanocrystalline, Sendust (FeSiAl), and FeNi80.

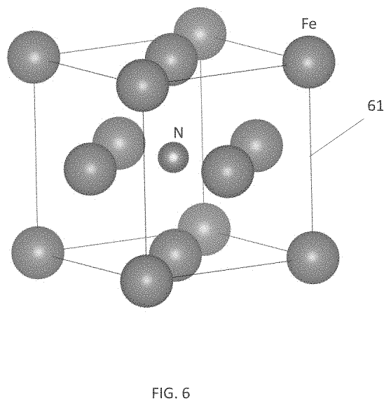

FIG. 6 shows a crystal structure 61 of the Fe₄₋ₓNₓ compound crystalline phase. The structure in FIG. 6 is face centered cubic with iron atoms in the corners and on the faces of the cube and with a Nitrogen atom sitting in the center of the cube. Though, in some of the structure embodiments, nitrogen can be missing because of the Fe₄₋ₓNₓ stoichiometry.

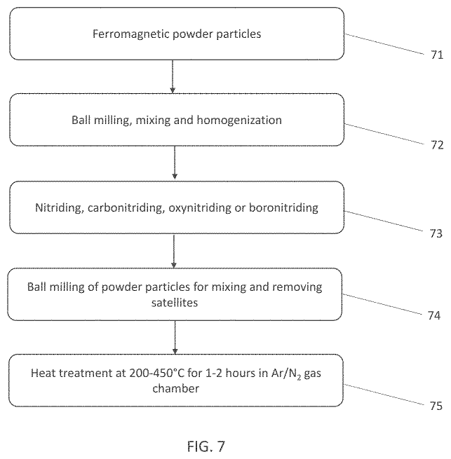

FIG. 7 shows a flow diagram of an exemplary process of milling ferromagnetic powder particles. At step 71, ferromagnetic powders are provided. The provided ferromagnetic powders can include Fe, FeₓNi₁₋ₓ, FeₓCo₁₋ₓ, FeₓSi₁₋ₓ, FeSiCuB, FeₓN_{y}, FeₓN_{y}C_{z}, FeₓN_{y}O_{z}, FeₓN_{y}B_{z}, FeₓN_{y}M_{z}, where (M=CO, BC) and x=0.5-95 (e.g., x=75-95) at %, y=1-30 (e.g., y=5-25) at %, z=0.5-20 (e.g., z=5-15) at %. At step 72, the ferromagnetic powders are milled to improve the magnetic and structural performances. This milling can include ball milling where the ferromagnetic powders are milled for homogenized mixing and synthesizing new alloy with Cr, Mn, Al, Ni, Co, and Zn. The ball milling can be operated at room temperature at a rotational rate of, for example, 1000 rpm in Ar/N₂ media. At step 73, these ball-milled powders can be nitrided, carbonitrided, oxynitrided, and/or boronitided. At step 74, the powder particles can be ball milled again at low to medium speed, such as at a rotational rate of 100-500 rpm in N₂/Ar to remove the satellites and homogenize the particle size and morphology. At step 75, the powders can be placed in a furnace and heat-treated at a temperature of, for example, 200-450C for 1-2 hours in Ar/N₂ environment.

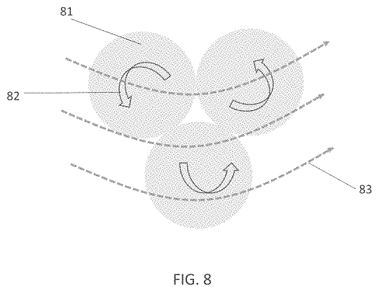

FIG. 8 shows one example of motion of the magnetic flux and eddy current relative to particles 81. Eddy current 82 can move interparticle due to the induced voltage from the magnetic field 83 along the particles 81. Reduction of the eddy current flow can reduce the magnetic core loss and increase efficiency. The eddy current flow can be reduced using an electrically isolating material in the coating shell of each powder particle 81. However, an electrically isolating material such as Al₂O₃ or MgO, or SiO₂ would also hinder the magnetic flux path, which would reduce the permeability and increase hysteresis loss.

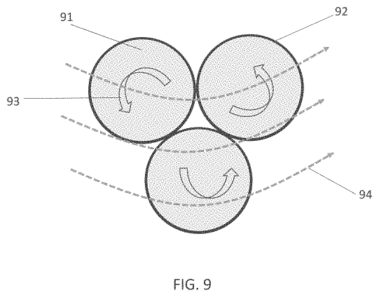

An improved solution for restricting the flow of eddy current and continuing the path for magnetic flux would be a ferrimagnetic coating in the powder particle shell. FIG. 9 shows an exemplary illustration of the ferromagnetic material(s) 92 forming, at least in part, a shell of the powder particle 91. The ferrimagnetic material(s) forming the shell can be oxides of ferromagnetic metals such as Fe₂O₃, Fe₃O₄, Mn₁₋ₓZnₓ.Fe₂O₄(MnZn-Ferrite) or Ni₁₋ₓZnₓ.Fe₂O₄ (NiZn-Ferrite). The thickness of the coating can be, for example, from 0.05-0.50 μm or from 0.05-1.00 μm.

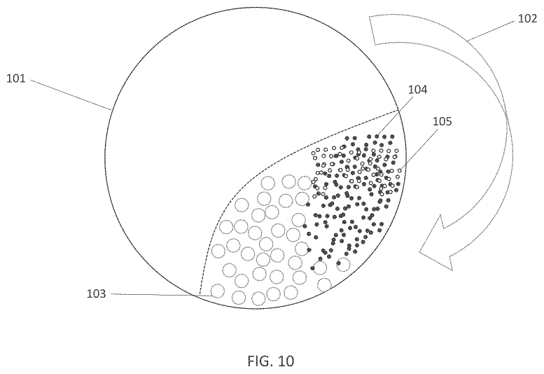

The coating of ferrimagnetic or nonmagnetic materials can be deposited on the ferromagnetic powder particles by using a high-energy planetary ball milling system 101, an example of which is shown in FIG. 10. The ferromagnetic particles 104 can be mixed with coating material 105, and steel (e.g., stainless steel) balls 103. The powder particles and the coating materials are mixed via rotation of the system, such as in a rotational direction 102, at a rate of, for example, from 100-2000 rpm. The powder ferromagnetic particles are mixed with ferrimagnetic or nonmagnetic materials, for instance, at a ratio of 100:1 to 200:1 ferromagnetic particles 104 to ferrimagnetic or nonmagnetic coating materials 105 and milled in N₂/Ar media for 2-6 hours. The rotation of the system vessel can help in providing a chemical reaction and place the coating materials on the surface of the powder ferromagnetic particles. The coating materials can be, for example, one or more of Al₂O₃, MgO, SiO₂, Fe₂O₃, Fe₃O₄, Mn₁₋ₓZnₓ.Fe₂O₄(MnZn-Ferrite) or Ni₁₋ₓZnₓ.Fe₂O₄(NiZn-Ferrite).

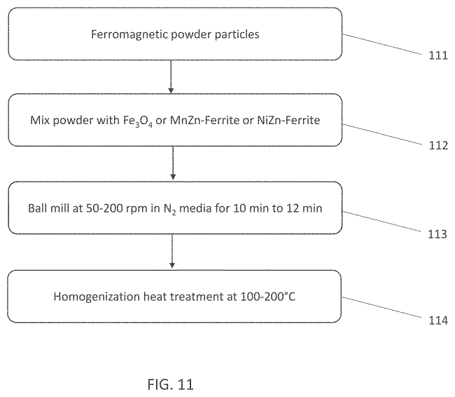

In another example, the coated powder particles (111) can be ball milled (112) at 50-200 rpm in N₂/Ar media (113) to remove satellites and homogenize the size and morphology, shown in FIG. 11. The particles are homogenized, for example, by heat treating (114) at 100-200° C. in Ar/N₂ media for 1-2 hours.

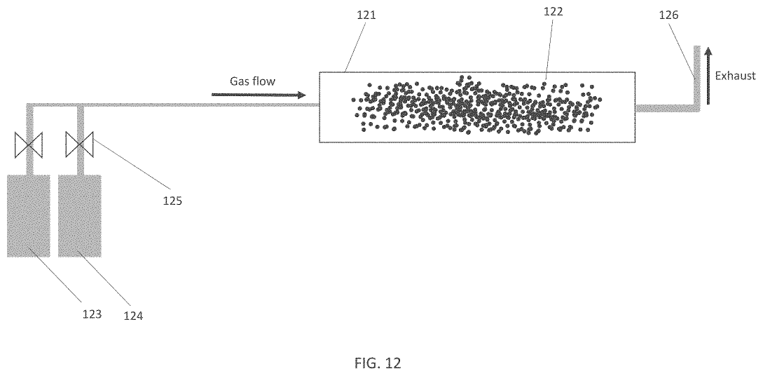

In another example, the coating on the ferromagnetic powder particles is synthesized via controlled reactive-gas treatment, one example of which is shown in FIG. 12. The powder particles 122 are oxide-treated by using O₂ as the reactive-gas 123 and/or 124 in the reactor 121 at, for instance, 200-500° C. for 10-30 minutes (e.g., selectively communicated to the reactor 121 via valve 125 and output via exhaust 126). This reaction can result in an Iron Oxide, Fe₃O₄, layer on the ferromagnetic particle. The thickness of the resulting coating can be, for instance, from 0.05-0.50 μm or from 0.05-1.00 μm.

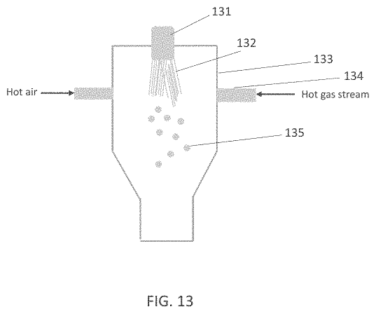

In another example, the coating on the ferromagnetic particles can be synthesized using a spray method, an example of which is shown in FIG. 13. The particle slurry 132 can be introduced into the tower chamber 133 via inlet 131. Hot gas stream 134 is sprayed on the slurry particles 132 to form synthesized particles 135. The synthesized particles 135 can dry out while falling through the tower 131.

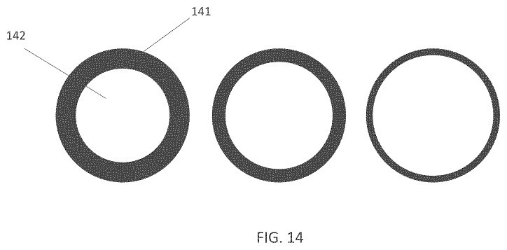

FIG. 14 shows the variation of the thickness of the coating 141 on the ferromagnetic particles 142. The thickness of the coating can be mainly controlled by coating slurry concentration. The slurry dry weight, for instance, can be less than 3.0% of the ferromagnetic particle weight to achieve the noted range of coating thicknesses.

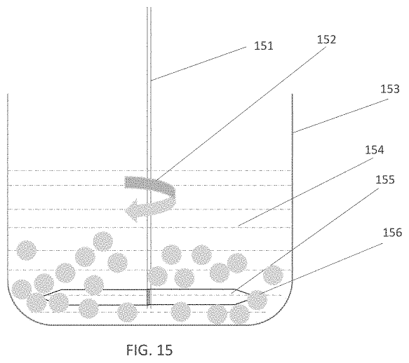

The coating material can be deposited on the powder particles by using a “blade” mixing process shown in FIG. 15. The solution of phosphate or sodium metasilicate or resin or MgO or Al₂O₃ or SiO₂ is used for mixing micron size particles using the rod propeller. The mixing can be done at 250-1900 rpm for 0.5-3 hours. The mixing helps the particles to have an uniform coating thickness. The mixing rod 151 is attached to propeller blade 155 and helps to rotate solution 154 and particles 156 within container 153.

TABLE 1

| Coating material | Solvent | Solubility target |
|---|---|---|
| Phosphoric acid | Acetone | 1-3 vol % |
| Sodium metasilicate | Deionized water (DI | ~10 vol % |
| | water) | |
| Silicone resin | Xylene and Toluene | <10 vol % |
| MgO | DI Water/Acetone | N/A |
| SiO₂ | Acetone | N/A |

The coating thickness can be controlled by the composition of the coating material and the method used for applying the coating. For example, in the slurry spray method shown in FIG. 13, the rate of coating slurry spray and the flow rate of the gas for the ferromagnetic particle floating can be used control the coating thickness, for instance to be within the noted range of coating thicknesses.

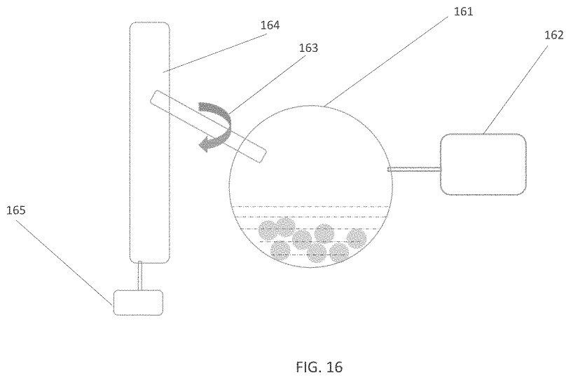

The slurry drying can be done by “RotoVap” process. The process can be executed by rotary evaporation of solvent shown in FIG. 16. The vessel 161 is rotated with particles and solvent and connected to a vacuum 165 via column 164 and rotary arm 163. The vessel is connected to a pump 162 to lower down the pressure. Under the vacuum, the solvent evaporates at different pressure as shown in the following Table 2:

TABLE 2

| Solvent | Pressure for evaporation | Boiling point |
|---|---|---|
| Water | <3 Torr | 100° C. |
| Acetone | <10 Torr | 56° C. |
| Toluene | <10 Torr | 110° C. |
| Xylene | <5 Torr | 138° C. |
| Ethanol | <5 Torr | 78° C. |

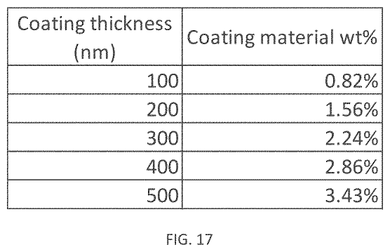

The slurry for synthesizing the coating can contain mechanically soft particles to enable the plastic movement of the grains and grain boundaries in the ferromagnetic particles during the compaction process. In one example, shown in FIG. 16, the mixing of the Silicone resin can be mixed with Toluene between 1-5 wt % of powder. The coating composition, the mixing speed and mixing time can be optimized to obtain a specific thickness of the shell coating. FIG. 17 illustrates a table that shows a relationship between coating thickness and coating material wt % relative to the ferromagnetic powder on which the coating is applied.

In one example, Ferromagnetic powders were mixed with Phosphoric acid and Iron phosphate coating shell was formed. The coating thickness is amorphous and 40-70 nm thick.

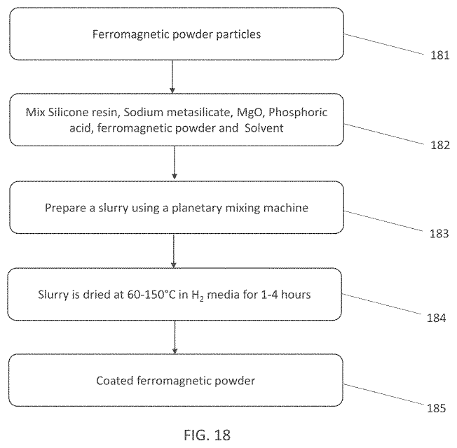

In another example, the slurry is dried with heat treatment in a controlled, reducing atmosphere. FIG. 18 illustrates providing ferromagnetic powder particles (181) and an exemplary mixture of slurry with silicone resin, sodium metasilicate, MgO, Talc, SiO₂, Al₂O₃ and solvent can be provided (182) for mixing with these ferromagnetic powder particles. The mixture can be mixed in a planetary mill machine (183). Then the slurry can be dried at 60-150° C. for 1-4 hours in reducing atmosphere (H₂ or N₂ media) (184) to produce the coated ferromagnetic particles (185).

TABLE 3

| Coating material | Solvent |
|---|---|
| Phosphoric acid | Acetone |
| Sodium metasilicate | Deionized water (DI water) |
| Silicone resin | Xylene and Toluene |
| MgO | DI Water/Acetone |
| SiO₂ | Acetone |

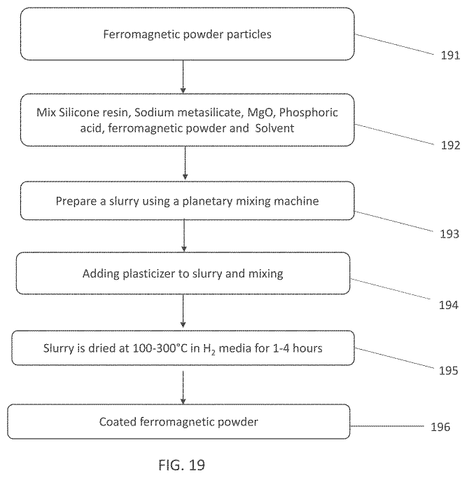

In another example, shown at FIG. 19, ferromagnetic powder particles are provided (191) and an exemplary mixture of slurry with silicone resin, sodium metasilicate, MgO, Talc, SiO₂, Al₂O₃ and solvent can be provided (192) for mixing with these ferromagnetic powder particles. A slurry can be prepared (193) and mixed with plasticizers such as starch, soap, sugar, glycerin, steric, and/or ammonium lignosulfonate (194). The plasticizer can enable more flexible movement of the powder particles during compaction and help to avoid any tear of coating in the grain boundary. The addition of the plasticizer can be useful for the formation of a functionalized magnetic core for high-frequency application to keep the ferromagnetic grains separated by electrically insulating coating. The slurry is dried (195) and the ferromagnetic powder is coated (196).

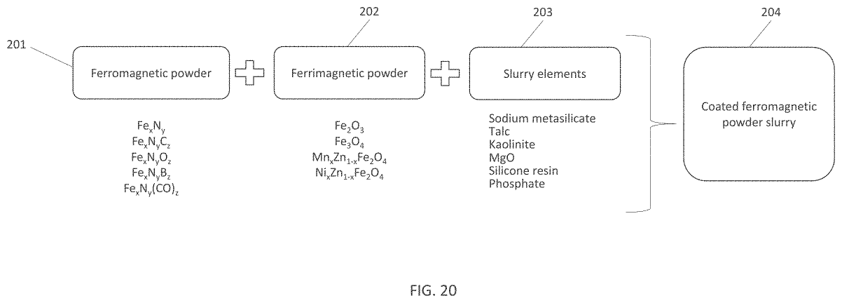

FIG. 20 shows exemplary steps for producing a coated ferromagnetic particle with a ferrimagnetic coating. The ferromagnetic powders are provided (201) (e.g., any one or more of those listed below box 201-FeₓN_{y}; FeₓN_{y}C_{z}; FeₓN_{y}O_{z}; FeₓN_{y}B_{z}; FeₓN_{y}(CO)_{z}) and can be mixed with provided ferrimagnetic powders (202) (e.g., any one or more of those listed below box 202-Fe₂O₃; Fe₃O₄; MnₓZn₁₋ₓFe₂O₄; NiₓZn₁₋ₓFe₂O₄) and then this mixture can be mixed with the slurry element(s) 203 (e.g., one or more of those listed below box 203-sodium metasilicate; talc; kaolinite; MgO; silicone resin; SiO₂; Al₂O₃; and phosphate). The slurry elements at box 203 can include any one or more of sodium metasilicate, talc, kaolinite, MgO, silicone resin, SiO₂, Al₂O₃, phosphate, Plasticizers, and Deionized Water. The components 201, 202, and 203 can be mixed in a rotary reactor at, for instance, 10-200 rpm for 10-120 minutes in N₂ or Ar media which can result in a coated ferromagnetic powder particle slurry 204.

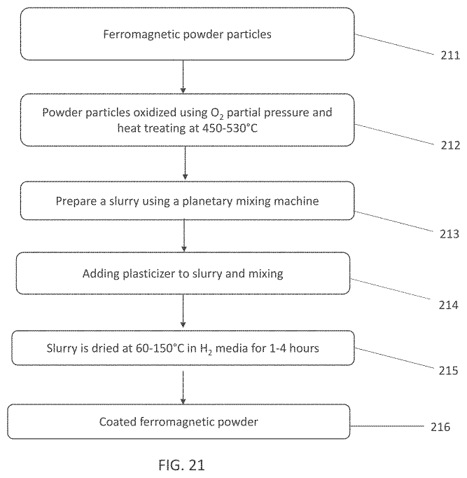

In another example, the slurry can then be dried with a heat treatment. FIG. 21 shows the treatment of the slurry with ferromagnetic powder, ferrimagnetic powder, slurry components, and plasticizers. Ferromagnetic powder particles are provided (211) and oxidized using O₂ (e.g., partial pressure) and heat treated at 450-530° C. (212). The slurry is then prepared (213) and a plasticizer is added to the slurry and mixed (214). The slurry can be heat dried (215) at, for instance, 60-150° C. for 1-4 hours in reducing atmosphere (H₂ media). The dried particles can have a ferrimagnetic layer in the shell and ferromagnetic materials in the core (216).

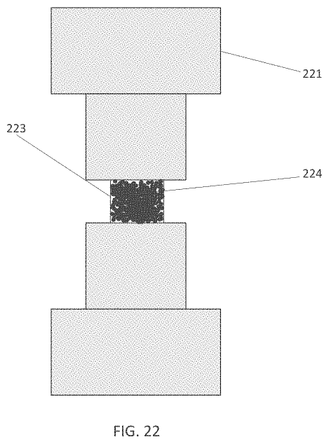

Magnetic cores can be made by compacting the one or more of the coated ferromagnetic powders described elsewhere herein. FIG. 22 shows one exemplary technique of compacting such ferromagnetic powders to form a magnetic core. The powder particles 223 can be compacted inside a compression die 224 positioned at a compressor 221. The pressure of the die 224 can be controlled via a pressure valve. The powders can be compacted at, for instance, 100-2500 MPa pressure. The resulting compacted powders can have a density of 85-90%.

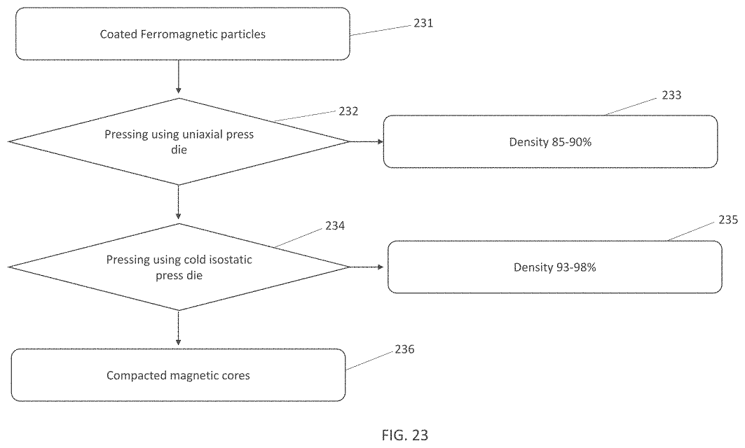

FIG. 23 shows one example of the powder compaction performed in two stages. In the first stage, provided coated ferromagnetic powder particles (231) can be compacted using the uniaxial pressing process (232). This first compaction stage can produce a compacted powder particle density of 85-90% (233). Then, at a second stage, the particles can be compacted in cold isostatic pressing (CIP) die (234). As noted, the first stage of compaction can result in 85-90% density of powder particles, noted at (233), and the subsequent, second stage of compaction, in the illustrated example round CIP, can result in 93-98% density, noted at (235), magnetic cores (236).

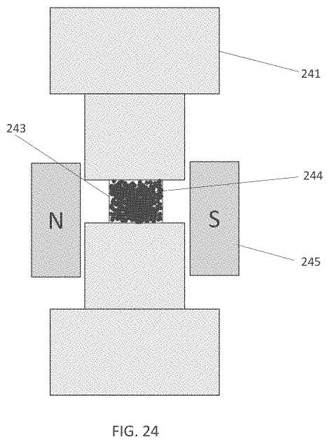

In another example, the particles can be compacted using magnetic field induction induced at a compressor 241, an example of which is shown at FIG. 24. The electromagnet 245 shown in FIG. 24 can be used for inducing a magnetic field in the ferromagnetic particles 243 and/or 244. In this case, the particles can be aligned to a specific, desired direction by the magnetic compaction process using the electromagnet 245. The magnetic compaction of isotropic and anisotropic particles can produce a directionally magnetizable magnetic core. Such directionally magnetizable cores can be useful for transformers and some motor applications.

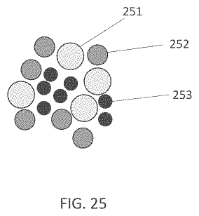

The magnetic core can be formed by adding additional magnetic particles, for instance magnetic particles of different sizes. Relatively high filling factors for the magnetic core can be obtained by using 60-70% wt of biggest size particles, 20-30% wt of medium size particles, and 5-10% wt of smallest size particles. In one example, shown in FIG. 25, particles 251 are the biggest size, particles 252 the medium size, and particles 253 the smallest size. These particles 251, 252, 253 can be mixed in a ball milling system. The mixture can enable a filling rate between 90-98%.

In one example, the magnetic core can be etched with 50% HNO₃ for 0-30 seconds or Baume HNO₃ for 2-5 minutes at 40-60° C. The etched core can then be heat-treated at 40-60° C. for 5-60 seconds.

The etched cores can be oxidized by heat-treating the cores in the air for 350-600° C. for 10-90 minutes. The oxidation can increase the mechanical strength of the magnetic core and reduce the core loss. Improvement of functional performance can be associated with the moisture reduction in the magnetic core.

In another example, the magnetic cores can be heat-treated at 350-500° C. for 1-2 hours in reducing atmosphere (H₂ media). The heat treatment helps in reducing excessive oxides on the surface and reducing internal stresses.

In another example, the magnetic cores can be insulated with enamel core paint. The enamel paint coating thickness can be, for example, from 1-10 μm.

### EXPERIMENTAL EXAMPLES

The following provides illustrative, non-limiting examples of the synthesis of embodiments of a high magnetic induction and high electrical resistivity magnetic material such as those disclosed elsewhere herein. As noted elsewhere herein, the high induction can help to reduce device size, and the high electrical resistivity can help to reduce associated magnetic core loss.

### Example 1

In this example, high magnetic induction and high electrical resistivity of the Iron Nitride phase, Fe₄₋ₓNₓ, shown in the plot of FIG. 5, has been demonstrated. In one case, the magnetic induction and electrical resistivity for the Iron Nitride phase, Fe₄₋ₓNₓ was found as approximately 1.8 T and approximately 220 μΩ-cm, respectively. In another case, the magnetic induction and electrical resistivity for the Iron Nitride phase, Fe₄₋ₓNₓ was found as approximately 1.6 T and approximately 300 μΩ-cm, respectively.

### Example 2

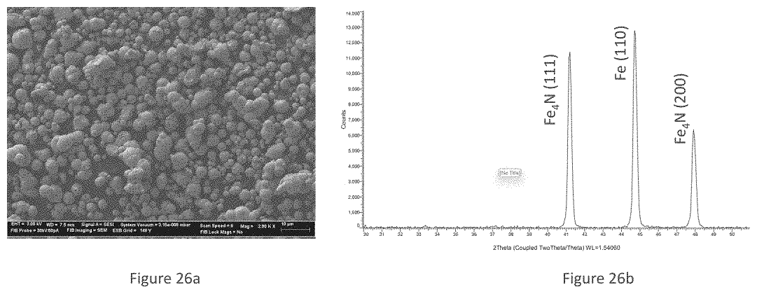

In another example, synthesis of Iron-Iron Nitride core-shell structure has been demonstrated. The core-shell synthesis was done via gas-solid reaction in a rotary furnace. 100 g Carbonyl Iron powder of 1-10 microns were used as precursor, shown in FIG. 26a. The powder was placed in a rotary tube with fins for fine mixing and a mixture of H₂ gas and NH₃ is flown through the tube bed. The particles reacted with the gas mixture to create Iron Nitride shell. The thickness of the shell was controlled via gas flow volume and the reaction time. The gas flow was mixed with 190 sccm H₂ and 114 sccm NH₃ and nitrided at 530° C. for 30 minutes.

The Fe₄₋ₓNₓ particles are characterized to understand the crystalline phase volume. The crystalline phase was characterized by x-ray diffraction (XRD). The XRD is shown in FIG. 26b.

TABLE 4

| | Major peak (hkl) | Angle (2θ) | Intensity (a.u.) |
|---|---|---|---|
| Fe₄N | 111 | 41.1 | 12000 |
| Fe | 110 | 44.76 | 13000 |

The intensity was used to calculate the volume fraction of Fe₄N, Iron Nitride phase in the particle system.

V_{Fe4N}=I_{Fe4N}/(I_{Fe4N}+I_{Fe})×100%=48%

V_{Fe}=100−V_{Fe4N}=52%

### Example 3

In another example, 200 g Carbonyl iron powder was nitrided in a rotating tube furnace at 530° C. for 1 hour in presence of NH₃/H₂ gas mixture. The NH₃/H₂ gas mixture was made using 114 sccm NH₃ and 190 sccm H₂.

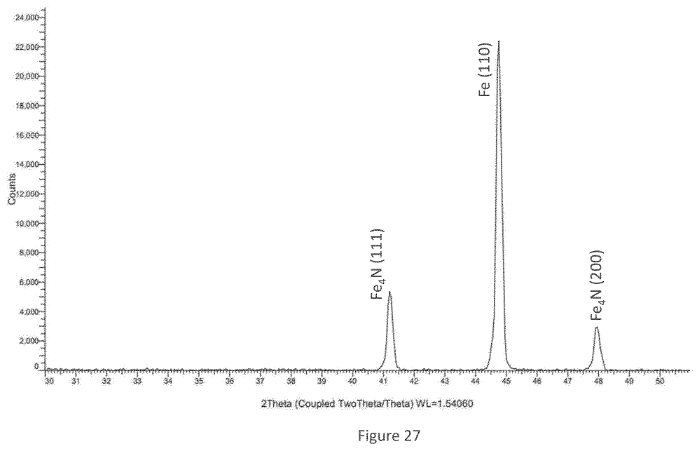

The Fe₄₋ₓNₓ particles are characterized to understand the crystalline phase volume. The crystalline phase was characterized by x-ray diffraction (XRD). The XRD is shown in FIG. 27.

TABLE 5

| | Major peak (hkl) | Angle (2θ) | Intensity (a.u.) |
|---|---|---|---|
| Fe₄N | 111 | 41.1 | 5500 |
| Fe | 110 | 44.76 | 22500 |

V_{Fe4N}=I_{Fe4N}/(I_{Fe4N}+I_{Fe})×100%≈20%

V_{Fe}=100−V_{Fe4N}=80%

### Example 4

In another example, 100 g Carbonyl iron powder was nitrided in a rotating tube furnace at 530° C. for 1 hour in presence of NH₃/H₂ gas mixture. The NH₃/H₂ gas mixture was made using 114 sccm NH₃ and 190 sccm H₂.

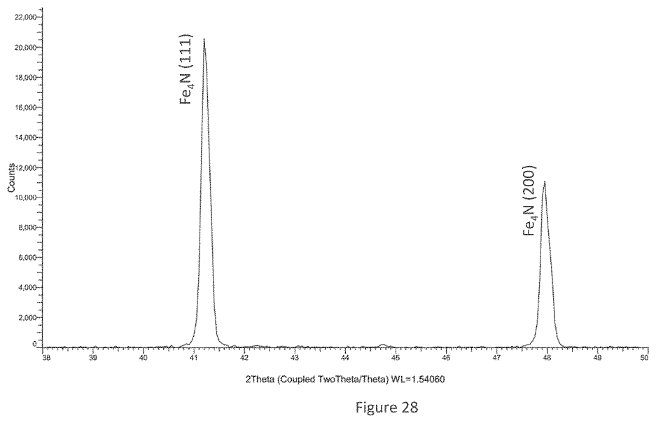

The Fe₄₋ₓNₓ particles are characterized to understand the crystalline phase volume. The crystalline phase was characterized by x-ray diffraction (XRD). The XRD is shown in FIG. 28.

TABLE 6

| | Major peak (hkl) | Angle (2θ) | Intensity (a.u.) |
|---|---|---|---|
| Fe₄N | 111 | 41.1 | 20500 |
| Fe₄N | 220 | 48.0 | 11000 |

V_{Fe4N}=I_{Fe4N}/(I_{Fe4N}+I_{Fe})×100%=100%

### Example 5

In another example, 150 g Carbonyl iron powder was nitrided in a rotating tube furnace at 530° C. for 1 hour in presence of NH₃/H₂ gas mixture. The NH₃/H₂ gas mixture was made using 114 sccm NH₃ and 190 sccm H₂.

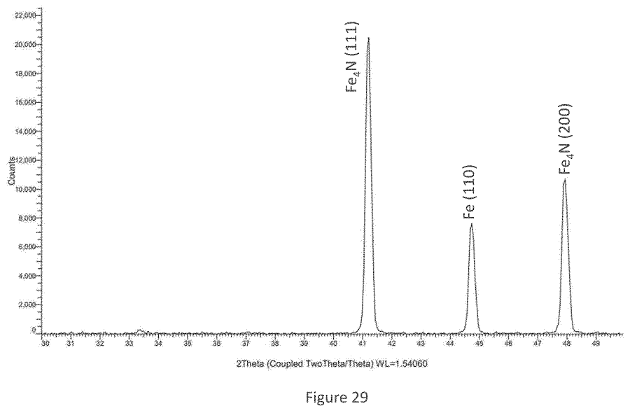

The Fe₄₋ₓNₓ particles are characterized to understand the crystalline phase volume. The crystalline phase was characterized by x-ray diffraction (XRD). The XRD is shown in FIG. 29.

TABLE 7

| | Major peak (hkl) | Angle (2θ) | Intensity (a.u.) |
|---|---|---|---|
| Fe₄N | 111 | 41.1 | 20500 |
| Fe₄N | 220 | 48.0 | 8000 |

V_{Fe4N}=I_{Fe4N}/(I_{Fe4N}+I_{Fe})×100%≈72%

V_{Fe}=100−V_{Fe4N}=28%

### Example 6

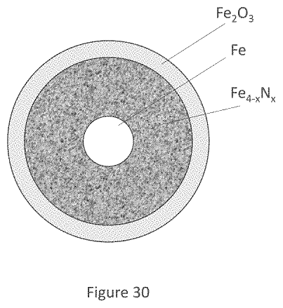

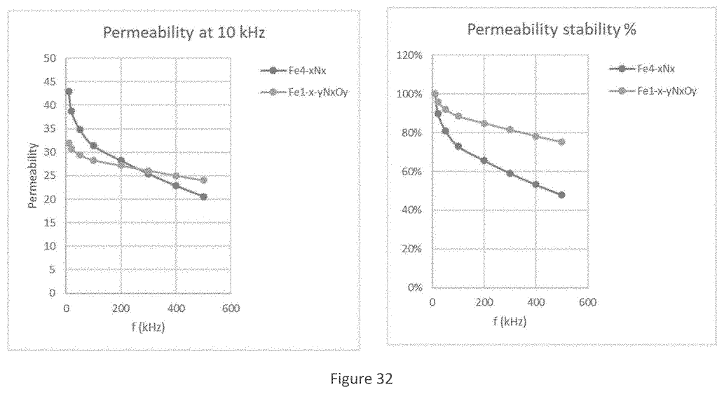

In another example (see plot of FIG. 32) the powder is oxidized post nitriding. The oxidation helps in increasing the resistivity of the material. Iron oxide, α-Fe₂O₃ has a resistivity of 1.58-5.62×10⁴ Ω-m. Iron and Iron Nitride has a resistivity of 5×10⁻⁷ Ω-m and 2-3×10⁻⁶ Ω-m. High resistivity iron Nitride shell helps in reducing core loss. The oxide layer is formed via solid-gas reaction in the rotary tube furnace. The nitrided particles are oxidized by using flowing compressed air in the tube or using a mix of hydrogen and compressed air. The particles are found with oxide shell with a nitride layer to the adjacent and Iron in the core. The particle class can be defined as Fe_{1-x-y}NₓO_{y}. The graphical representation of the core-shell structure is demonstrated in FIG. 30.

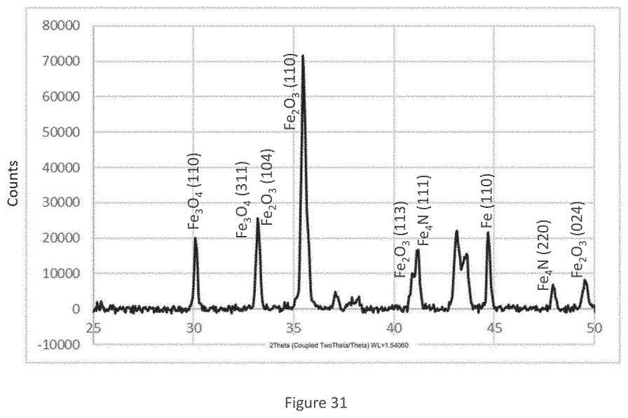

The oxynitrided particles are characterized to understand the crystalline phase volume. The crystalline phase was characterized by x-ray diffraction (XRD). The XRD is shown in FIG. 31.

TABLE 8

| | Major peak (hkl) | Angle (2θ) | Intensity (a.u.) |
|---|---|---|---|
| Fe₃O₄ | 110 | 30.1 | 2000 |
| Fe₃O₄ | 311 | 35.2 | 2700 |
| Fe₂O₃ | 104 | 35.2 | 2700 |
| Fe₂O₃ | 110 | 35.5 | 7100 |
| Fe₂O₃ | 113 | 41.5 | 1800 |
| Fe₄N | 111 | 41.1 | 1900 |
| Fe | 110 | 44.65 | 2100 |
| Fe₄N | 220 | 48.0 | 800 |
| Fe₂O₃ | 024 | 49.5 | 900 |

The oxynitrided powder, Fe_{1-x-y}NₓO_{y}, demonstrated in example 6, are compacted to test effectiveness of the oxide shell. The oxide shell insulation enables the magnetic permeability to be stable over a large permeability range. The magnetic cores prepared from oxynitrided powders.

The compaction was done at 1500 MPa to form a toroid core of 25 mm OD, 15 mm ID and 10 mm H. The maximum permeability is found as 43 and 32 for Fe₄₋ₓNₓ and Fe_{1-x-y}NₓO_{y}, respectively. The oxide shell is helps in improving the stability of the permeability of particles, shown in FIG. 31. The oxynitrided particle has permeability stability up to 75% relative to 48% for the case of only nitrided core at 500 kHz. The higher stability of permeability over the higher frequency is the result of increase in resistivity of the particle system with the oxide shell.

### Example 7

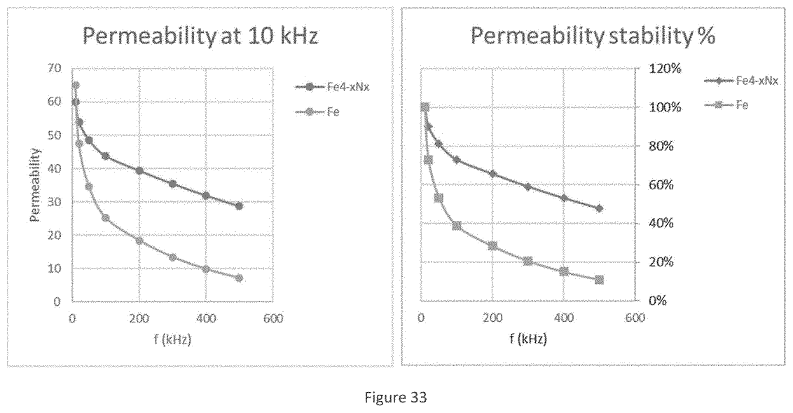

In another example (see plot of FIG. 33), the permeability stability of Fe₄₋ₓNₓ relative to pure Fe (Iron) was measured by compacting the powders in toroid core shape. The toroid of 25 mm OD, 15 mm ID and 10 mm H was prepared by using 1500 MPa uniaxial compaction force. Iron has a low electrical resistivity of 10 μΩ-cm whereas the Fe₄₋ₓNₓ has a resistivity of 200-300 μΩ-cm. The higher resistivity would enable a more stable permeability over a broad range of frequency.

The permeability of the Fe₄₋ₓNₓ and Fe core was measured as 60 and 65, respectively, shown in FIG. 33. However, at 500 kHz, the permeability of the Fe₄₋ₓNₓ core was found as 28 (48% stability at 500 kHz) whereas Fe core had a fast decline in permeability to 7 (only 11% stability at 500 kHz). The higher stability of the permeability at higher frequency was attributed to higher electrical resistivity of Fe₄₋ₓNₓ.

### Example 8

In another example, MgO and Silicone resin was used as an insulation layer for isolating the particles. Double stage insulation coating helped in reducing core loss and improving the permeability stability of the particles. We used Fe₄₋ₓNₓ as precursor as shown in example 2. The particles contained approximately 50 vol % Fe₄N and balance Iron, as shown in example 2. The coating was done via centrifugal planetary mixing process. In stage one, the particles were mixed with 30 nm MgO particles in an Acetone solution at 1000 rpm for 1 hour. Because of smaller size of the MgO particles, they get attached to the Fe₄₋ₓNₓ particles. Then the particles were dried at 60C for 30 minutes. In stage two, the dried particles were mixed with Silicone resin in a solution of Toluene. The centrifugal mixing occurred at 1000 rpm for 1 hour.

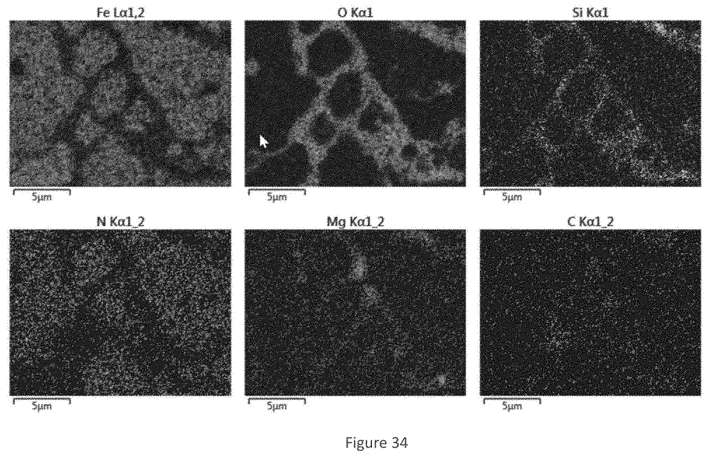

The coated particles are mixed with Zinc Stearate for compaction and compacted as toroid ring using 1500 MPa. FIG. 34 shows the EDS of the microstructure of the magnetic core. We found Si and Mg is dispersed in the grain boundary creating the electrically insulating layer.

The maximum permeability and stability of the compacted core was 20 at 10 kHz and 99% at 500 kHz. Core loss of the compacted core was found as 810 mW/cm³ at 100 kHz and B=0.05T.

### Example 9

In another example we used Silica (SiO₂) as a coating layer. The coating layer of Silica is deposited on the Fe₄₋ₓNₓ particle via sol-gel process. We used Fe₄₋ₓNₓ as precursor as shown in example 2. The particles are first dispersed in Absolute Ethanol and then mixed with 1-2 vol % APTES. Later the 0.3 mL/g TEOS is added as SiO₂ source and 0.04 g/mL of Ammonium Hydroxide (NH₄OH) is used to control the pH˜10. The solution is stirred for 10 hours at 60° C. and later powder is dried to obtain the coated particles.

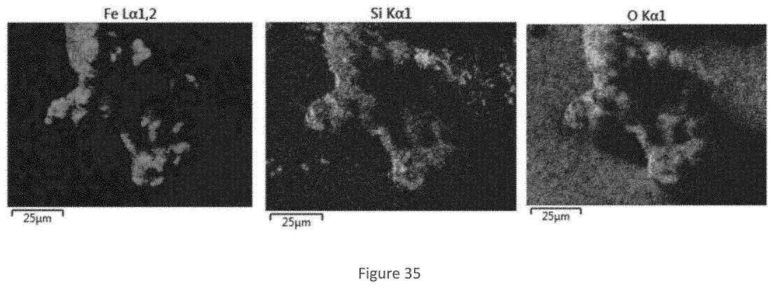

The EDS spectra of the Silica coating on Fe₄₋ₓNₓ particle is shown in FIG. 35.

The coated particles are then mixed with 0.4% Zinc Stearate and compacted at 1000 MPa. The permeability of the core was found as 25 at 10 kHz and the permeability is 99% stable at 500 kHz.

### Example 10

In another example, the Fe₄₋ₓNₓ particles, as demonstrated in example 2, were coated with phosphate via a reactive coating process. Partially nitrided Fe₄₋ₓN particles are used for the process. We used orthophosphoric acid as the source of the phosphate.

Fe³⁺+H₃PO₄->Fe₃(PO₄)₂+3H₂

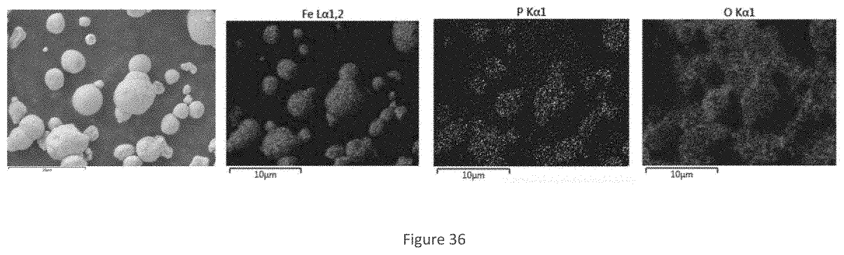

The Iron ion comes from the core of partially nitrided Iron. The Iron Phosphate layer on the Fe₄₋ₓNₓ particle acts as an electrically insulating layer. FIG. 36 demonstrates the EDS map of the phosphatized particles.

The coated particles are then mixed with 0.4% Zinc Stearate and compacted at 1000 MPa. The permeability of the core was found as 30 at 10 kHz and the permeability is 97% stable at 500 kHz. The core was found as 2000 mW/cm3 at 100 kHz and B=0.05 T.

### Example 11

In another example we used sodium metasilicate, Na₂SiO.9H₂O as the coating agent. We used Fe₄₋ₓN as the precursor particle, as demonstrated in example 2.

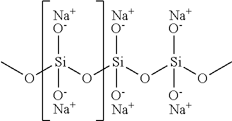

We mixed 1 wt % sodium metasilicate in DI water and used propeller blade to mix and rotate powder in the solution. Later the solution was dried and the coated particles were obtained.

The coated particles are then mixed with 0.4% Zinc Stearate and compacted at 1000 MPa. The permeability of the core was found as 30 at 10 kHz and the permeability is 99% stable at 500 kHz. The core loss was found as 1910 mW/cm3 at 100 kHz and B=0.05T.

### Example 12

In another example, Silicone resin was used as a coating agent, and Fe₄₋ₓN as the precursor particle.

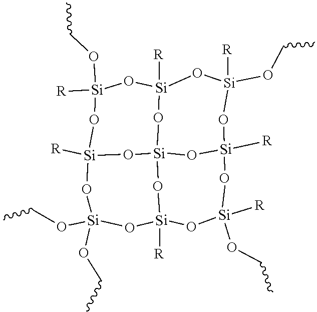

The silicone resin was used for the experiment. The powder particle Fe₄₋ₓNₓ demonstrated in example 2 was used as precursor. The silicone resin is soluble in Xylene and Toluene. We prepared a Silicone resin solution using 2 wt % Resin and mixed the particles in the resin solution using propeller blade. Later the solution was dried and the coated particles were obtained. The coated particles are then mixed with 0.4% Zinc Stearate and compacted at 1000 MPa. The permeability of the core was found as 35 at 10 kHz and the permeability is 99.5% stable at 500 kHz. The core loss was found as 1010 mW/cm³ at 100 kHz and B=0.05T.

### Example 13

The silicone resin used in the example, was crosslinked with the application of heat. We coated the Fe₄₋ₓNₓ particles demonstrated in example 2 with Silicone resin using propeller blade mixing process. The crosslinking of Silicone resin was heated for 1 hour at 204° C. The crosslinking of the polymer helps to build a magnetic core that is mechanically stable. The crosslinking of the polymer was done after the particles are compacted into a toroid core. The silicone resin coated particles are compacted as a toroid shaped magnetic core (25 mm OD and 15 mm ID) using 1000 MPa. The permeability of the particles was 35 and the permeability was stable up to 500 kHz. The core loss of the compacted toroid core was 780 mW/cm³ at 100 kHz/0.05T.

### Example 14

In another example, the Fe₄₋ₓNₓ particles prepared in example 2 was multi-stage coated with Phosphate, Sodium metasilicate and Silicone Resin. All of those materials are electrically insulating and can withstand up to 600° C. before any thermal decomposition.

Three stage coating was demonstrated to produce a magnetic core with high permeability stability and low eddy current loss. In stage 1, the particles are coated with Phosphate by immersing particles in Orthophophoric acid solution (1 wt % Phosphoric acid). Phosphate coating is done via a reactive process demonstrated in example 10. The solution was mixed at 250, 1000 and 1900 rpm for 30 minutes.

After the particles are coated with Phosphoric acid, we dried the particles and moved to stage 2. In stage 2, particles were coated with Sodium metasilicate. We used 1 wt % Sodium metasilicate solution in DI water, as demonstrated in example 11. Later the coated particles were dried, and we moved to third stage coating. The solution was mixed at 250, 1000 and 1900 rpm for 30 minutes.

Third stage coating was done with Silicone Resin. We created a solution with 2 wt % silicone resin with Toluene as solvent and mixed particles in the solution. All of the solution in all stages were mixed at 250-1900 rpm using a blade mixer. Finally, the particles were dried and we obtained three-stage coated particles.

The particles were mixed with 0.40 wt % Zinc Stearate and then compacted at 1500 MPa to 25 mm OD, 15 mm ID and 10 mm H toroid core. After the cores were made, the cores were cured at 204° C. for 1 hour. Later, the magnetic cores were annealed at 575C for 4 hours in N₂ environment for removing internal stress. Hence lower the hysteresis loss.

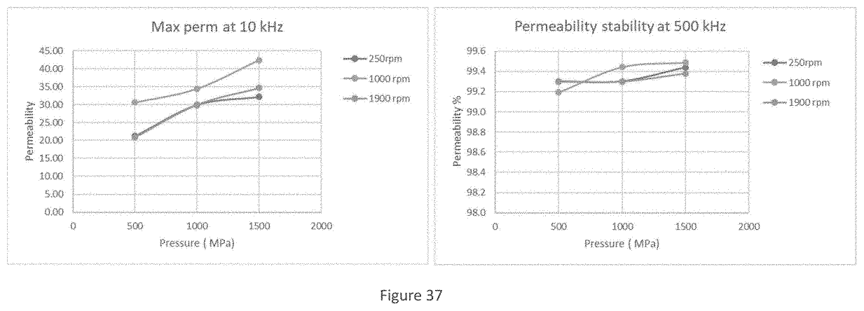

The permeability of the magnetic core was found as between 21 and 42. The stability of the permeability at 500 kHz was between 99.2-99.4%. The permeability with different mixing speed and compaction pressure is shown at the plot of FIG. 37 and detailed below at Table 9:

TABLE 9

| | Mixing speed (rpm) | | | | | |
|---|---|---|---|---|---|---|
| | 250 | | 1000 | | 1900 | |
| Compaction | | Permeabiity | | Permeabiity | | Permeabiity |
| pressure | Permeability | Stability % | Permeability | Stability % | Permeability | Stability % |
| (MPa) | at 10 kHz | at 500 kHz | at 10 kHz | at 500 kHz | at 10 kHz | at 500 kHz |
| 500 | 21.28 | 99.3% | 30.59 | 99.2% | 20.85 | 99.3% |
| 1000 | 29.95 | 99.3% | 34.43 | 99.4% | 30 | 99.3% |
| 1500 | 32.2 | 99.4% | 42.41 | 99.5% | 34.7 | 99.4% |

The core loss of the three-stage coating was found between 710 mW/cm³ to 1159 mW/cm³ at 100 kHz/B=0.05T. Core loss at different mixing speed and compaction pressure is shown below at Table 10:

TABLE 10

| Mixing speed | Compaction pressure (MPa) | | |
|---|---|---|---|
| (rpm) | 500 | 1000 | 1500 |
| | Core loss (mW/cm³) at 100 kHz/ B = 0.05 T | | |
| 250 | 1095.74 | 743.38 | 703.00 |
| 1000 | 923.95 | 709.51 | 657.62 |
| 1900 | 1159.84 | 710 | 654.17 |

The core loss, P_{cv} is result of two different losses—hysteresis loss, P_{hys} and Eddy current loss, Pₑ. The core:

P_{cv}=Pₕ+Pₑ=kₕ.f+kₑ.f² [equation 1]

kₕ and kₑ is the material constant for hysteresis loss and eddy current loss, respectively. f is the frequency of operation. By modifying the equation [1] we obtained:

P_{cv}/f=kₕ+kₑ.f [equation 2]

By fitting the P_{cv}/f vs. f, we can obtain the hysteresis loss constant and eddy loss current constant. The following Table 11 shows the separation of loss, Pₕ=hysteresis loss, Pₑ=Eddy current loss:

TABLE 11
Core loss, P_{cv} Separation

| | Mixing speed (rpm) | | | | | |
|---|---|---|---|---|---|---|
| Compaction | 250 | | 1000 | | 1900 | |
| Pressure | Loss (mW/cm³) at 100 kHz/B = 0.05 T | | | | | |
| (MPa) | Ph | Pe | Ph | Pe | Ph | Pe |
| 500 | 1040 | 55.74 | 860 | 63.95 | 1040 | 120 |
| 1000 | 670 | 73.38 | 600 | 109.51 | 650 | 115 |
| 1500 | 600 | 103 | 540 | 117.62 | 540 | 114 |

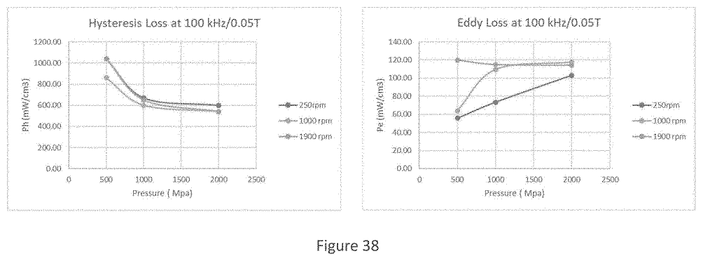

The hysteresis loss and eddy current loss at different mixing speed and compaction pressure is shown at the plot of FIG. 38.

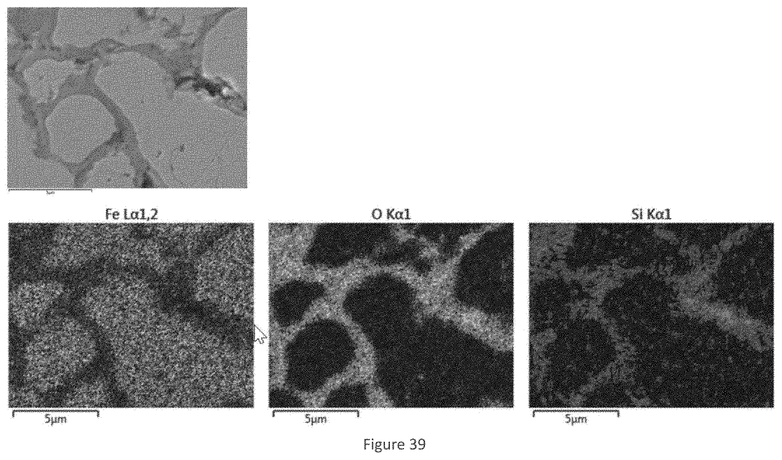

The toroid core made in this example was examined under the microscope to understand the distribution of coating layer. The SEM EDS is shown in FIG. 39. The boundary of particles contains Silicon (coming from Sodium metasilicate and Silicone resin). Phosphate layer is too thin to be visible. The particle boundary thickness is between 0.8-1.0 μm.

### Example 15

In another example, the particles made in example 2-5 was tested to measure the magnetic flux density and magnetization of the magnetic powder, the details of which are shown below at Table 12.

TABLE 12

| | Flux | Saturation |
|---|---|---|
| Fe₄N | density | magnetization |
| vol % | (T) | (emu/g) |
| 0 | 2.08 | 210 |
| 20 | 1.98 | 204 |
| 48 | 1.85 | 195 |
| 73 | 1.74 | 187 |
| 100 | 1.61 | 178 |

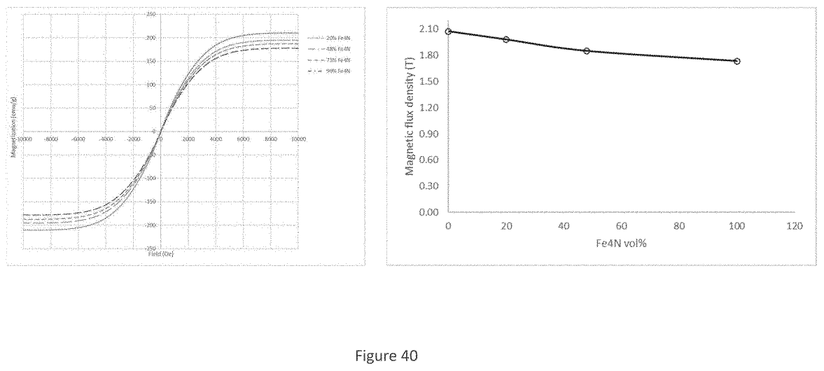

The magnetization and magnetic flux density in FIG. 40. The saturation magnetic flux density was tuned between 1.61T and 2.08T.

### Example 16

The magnetic cores prepared in example 14 were post annealed at different annealing temperature. We picked the coated powder which were mixed at 100 rpm and compacted with 100 MPa. High temperature annealing helps in reducing hysteresis loss by reducing the internal stress and defects from powder compaction process, as can be seen from the results shown below at Table 13.

TABLE 13

| Annealing | Hysteresis loss at 100 kHz/ |
|---|---|
| temperature | B = 0.05 T |
| (° C.) | (mW/cm³) |
| 450 | 1000 |
| 475 | 897 |
| 500 | 2000 |
| 525 | 790 |
| 550 | 650 |
| 575 | 540 |
| 600 | 1200 |

### Example 17

In another example, we used larger particles to be processed via ball mill machine. We reduced the size of the particles and used different size particles to improve the fill factors of the magnetic cores. The Iron powder was placed in a rotary tube with fins for fine mixing and a mixture of H₂ gas and NH₃ is flown through the tube bed. The particles reacted with the gas mixture to create Iron Nitride shell. The thickness of the shell was controlled via gas flow volume and the reaction time. We mixed the gas flow with 190 sccm H₂ and 114 sccm NH₃ and nitrided at 530° C. for 6 hours.

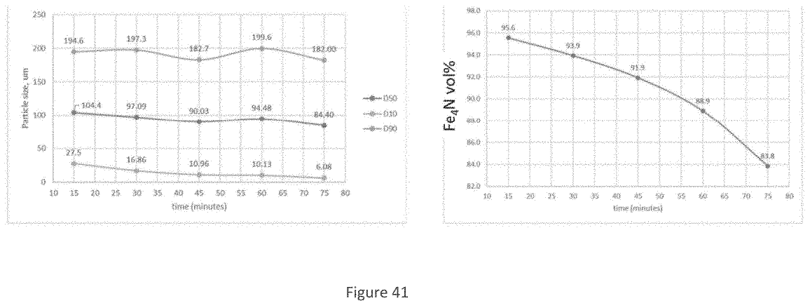

The particles are of the size of D50=131 μm. The particles were nitrided to 99 vol % Fe₄N. Later, the particles are ball milled with 10:1 ball to powder ratio at 200 rpm with Toluene solution in the vial. The powder was ball milled for 10 minutes to 75 minutes. FIG. 41 shows the impact of milling time on particle size.

We improved the fill factor of a magnetic core by mixing different particle size loading. The most ideal percolation happens with 7:1 particle size. We sieved particles according to different sizes and mixed 130 microns and 17 microns particles in 85:15 ratio.

The particles were coated with three-stage coating process described in example 14. Later, the coated particles were compacted with 1000 MPa. We found a change in density of core post-compaction, as can be seen from the results shown below at Table 14.

TABLE 14

| | Density of magnetic core, |
|---|---|
| | OD 25 mm, ID 15 mm, H 5 mm |
| 131 microns | 5.75 g/cm³ |
| 17 microns | 5.50 g/cm³ |
| 131 microns (85 vol %) | 6.10 g/cm³ |
| 17 microns (15 vol %) | |

### Example 19

In another example, mechanical alloy was synthesized using the ball milling system. We used 5 10 wt % Cr mixed with balance Carbonyl Iron. The ball milling parameters were: Ball to powder 10:1, milling time 24 hours and milling speed 500 rpm.

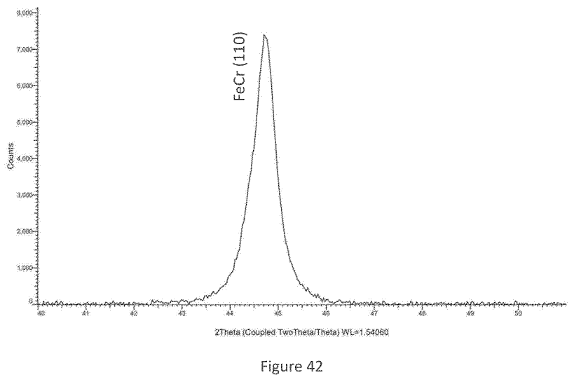

The particles are cold welded during the milling process and created a new alloy through the particles. The XRD of the Fe—Cr alloy and reference Fe and Cr powder is shown in FIG. 42. The alloy has a body center (BCC) crystal structure.

Alloying with Chromium helps in tuning the magnetic properties such as lower core loss and higher corrosion resistance.

The following provides a numbered listing of various exemplary embodiments within the scope of the present disclosure:

1. A composition including Iron, Nitrogen, and/or Carbon, or Oxygen or Boron—FeₓN_{y}, FeₓN_{y}C_{z}, FeₓN_{y}O_{z}, FeₓN_{y}B_{z}, FeₓN_{y}M_{z}, where (M=CO, BC) and x=0.5-95 (e.g., x=75-95) at %, y=1-30 (e.g., y=5-25) at %, z=0.5-20 (e.g., z=5-15) at %. Such compositions can have both high magnetic induction and high resistivity.

2. A method comprising providing ferromagnetic particles in a reactive chamber, controlling an introduction of one or more gases into the reactive chamber, synthesizing, as a result of introducing the one or more gases into the reactive chamber, a composition of the ferromagnetic particles that include at least one of FeₓN_{y}, FeₓN_{y}C_{z}, FeₓN_{y}O_{z}, FeₓN_{y}B_{z}, FeₓN_{y}M_{z}, where (M=CO, BC) and x=0.5-95 (e.g., x=75-95) at %, y=1-30 (e.g., y=5-25) at %, z=0.5-20 (e.g., z=5-15) at %. In this method, the chemical composition can control the functional magnetic and electrical properties of the resulting product.

3. A method comprising using one or more reactive gases to produce a magnetic material composition that includes at least one of FeₓN_{y}, FeₓN_{y}C_{z}, FeₓN_{y}O_{z}, FeₓN_{y}B_{z}, FeₓN_{y}M_{z}, where (M=CO, BC) and x=0.5-95 (e.g., x=75-95) at %, y=1-30 (e.g., y=5-25) at %, z=0.5-20 (e.g., z=5-15) at %. The reactive gases can be NH₃, O₂, H₂, and/or CO. The reactive gases can be introduced into the reactor chamber while the powder particles in the chamber are heated to a temperature of 400-750° C. for 6-24 hours.

4. The method of embodiment 3 or 4, wherein the reactor is rotated at 1-5 rpm, and wherein the powder particles are mixed with alumina balls to facilitate a homogenous mixing and homogenous sizing.

5. The method of embodiment 3 or 4, wherein the powder particles are ball milled at a rotational rate of 100-2000 rpm at room temperature in Ar/N₂ media. The ball milling of powder particles can help in homogenizing the size and morphology and reducing any satellites.

6. The method of embodiment 3 or 4, wherein the magnetic property of the resulting composition results, at least in part, by controlling the interstitial atomic compositions and post-heat treatments. The interstitial composition, such as Nitrogen, Carbon, Oxygen, or Boron composition, can be controlled by the reactive gas flow. The composition of interstitial atoms can also control the crystal structure, which can be a factor in determining the magnetic interactions in the atoms. The post-treatment of the powder particles can include milling at a rotational rate of 100-500 rpm in Ar/media, heat treatment at a temperature of 200-600° C. for 2-8 hours in an N₂/Ar environment.

7. The method of embodiment 3 or 4, wherein the powder particles are ball milled to remove satellites and reduce the particle size and shape difference. The powder particles can be milled at a rotational rate of 100-2000 rpm in Ar/N₂ media and post heat-treated at a temperature of 200-600° C. for 2-8 hours in an Ar/N₂ environment to reduce any internal stress.

8. The ferrimagnetic materials such as NiZn-Ferrites, MnZn-Ferrite, Fe₂O₃, and/or Fe₃O₄ or other nonmagnetic materials such as Phosphate, SiO₂, Al₂O₃, Sodium metasilicate, Silicone resin, Epoxy resin or MgO can be grown on the surface of the ferromagnetic materials described in embodiment 3 or 4. The powder ferromagnetic particles are mixed with ferrimagnetic or nonmagnetic materials between 100:1 and 200:1 ratio, powder ferromagnetic particles to ferrimagnetic or nonmagnetic materials, and milled at 100-2000 rpm in N₂/Ar media for 3-12 hours. The coating thickness can be controlled to be from 0.05 to 0.50 μm or from 0.05-1.00 μm.

9. The ferromagnetic powder described in embodiment 3 or 4, is coated with a ferrimagnetic material on the shell. The Ferrimagnetic materials can be of Fe₂O₃ or Fe₃O₄. The Iron Oxide, Fe₂O₃ or Fe₃O₄, on the ferromagnetic particles are grown by heat-treating the particles in a furnace at 450-550° C. for 30-120 minutes. The coating thickness is controlled to be from 0.05 to 0.50 μm or from 0.05-1.00 μm.

10. The ferrimagnetic materials such as NiZn-Ferrites, MnZn-Ferrite, Fe₂O₃ and/or Fe₃O₄ or other nonmagnetic materials such as Phosphate, SiO₂, Al₂O₃, or MgO can be grown on the surface of the ferromagnetic materials described in embodiment 3 or 4 by using a spray coating process. The ferrimagnetic or nonmagnetic coating materials can be sprayed on the ferromagnetic particles. The coating thickness is controlled to be from 0.05 to 0.50 μm or from 0.05-1.00 am.

11. The ferromagnetic particles described in embodiment 3 or 4 are coated with ferrimagnetic or nonmagnetic materials described in embodiment 8, 9, or 10 by using the slurry method. A slurry is prepared by mixing solvent (I.e. DI water, Acetone, Toluene, etc.), ferromagnetic materials, ferrimagnetic or nonmagnetic materials, Talc, Kaolin, SiO₂, Al₂O₃, and some plasticizers.

12. The slurry described in embodiment 11 is prepared by mixing ferromagnetic powder described in embodiment 3 or 4, 1-4 wt % of ferrimagnetic or nonmagnetic powder described in embodiment 8,9 or 10, 0.1-1.0 wt % of Talc or Mica or Kaolin and 5-20× volume of solvent relative to ferromagnetic powder volume.

13. The slurry described in embodiment 12 is dried in air or N₂ or H₂ media at 60-150° C. for 1-4 hours.

14. The slurry described in embodiment 12 is dried using rotational vaporizing system whereas the solvent vaporized at certain pressure between 3-10 Torr.

14. The coated ferromagnetic powders are uniaxially pressed at 100-2500 MPa pressure for 5-60 seconds. Then, the powders are compacted via cold isostatic pressing.

15. The coated ferromagnetic powder particles are magnetically aligned by using the pressing in the presence of a magnetic field generated by the presence of an electromagnet. The particles are compacted at 100-2500 MPa at 0.2-1.5T magnetic field for 5-20 minutes with a follow-on cold isostatic pressing.

16. The optimized filling factor of the magnetic core is obtained by using different size magnetic cores. The core is made from 60-70% wt of the biggest size particles, 20-30% wt of medium size particles, and 5-10% wt of smallest size particles.

17. The magnetic core is etched with HNO₃ to reduce surface defects and increase functionality.

18. The magnetic core is treated in the air or O₂ media for 350-600° C. for 10-90 minutes to increase mechanical strength, magnetic induction, and permeability.

19. The magnetic core is finally heat-treated in a reducing atmosphere at 350-600° C. Later, the core is painted with enamel to increase core strength.

Various examples have been described with reference to certain disclosed embodiments. The embodiments are presented for purposes of illustration and not limitation.

One skilled in the art will appreciate that various changes, adaptations, and modifications can be made without departing from the scope of the invention.

What is claimed is:

1. A compound having the formula (1):
FeₓN_{y}
wherein x=0.5-95 at %, and wherein y=1-30 at %.

2. The compound of claim 1, wherein x=75-95 at %.

3. The compound of claim 2, wherein y=5-25 at %.

4. A compound having the formula (2):
FeₓN_{y}O_{z}
wherein x=0.5-95 at %, wherein y=1-30 at %, and wherein z=0.5-20 at %.

5. The compound of claim 4, wherein x=65-90 at %.

6. The compound of claim 5, wherein y=5-25 at %.

7. The compound of claim 6, wherein z=5-10 at %.

8. A compound having the formula (3):
FeₓN_{y}C_{z}
wherein x=0.5-95 at %, wherein y=1-30 at %, and wherein z=0.5-20 at %.

9. The compound of claim 8, wherein x=65-90 at %.

10. The compound of claim 9, wherein y=5-25 at %.

11. The compound of claim 10, wherein z=5-10 at %.

12. A magnetic core comprising:
a magnetic material having the formula: FeₓN_{y}, wherein x=0.5-95 at %, and wherein y=1-30 at %; and
a coating applied to the magnetic material to provide an electrical insulation layer.

13. The magnetic core of claim 12, wherein the coating comprises a ferrimagnetic material that forms a coating over the magnetic material.

14. The magnetic core of claim 13, wherein the ferrimagnetic material is selected from the group consisting of: Fe₂O₃; Fe₃O₄; Mn₁₋ₓZnₓ.Fe₂O₄; and Ni₁₋ₓZnₓ.Fe₂O₄.

15. The magnetic core of claim 14, wherein a thickness of the coating formed by the ferrimagnetic material ranges from 0.05-1.00 μm.

16. The magnetic core of claim 14, wherein x=75-95 at % and y=5-25 at %.

17. The magnetic core of claim 14, further comprising:
a slurry element selected from the group consisting of: sodium metasilicate; talc;
kaolinite; MgO; silicone resin; SiO₂; Al₂O₃; and phosphate.

18. A method comprising the steps of:
providing ferromagnetic particles in a reactive chamber; and
introducing one or more gases into the reactive chamber to synthesize a magnetic material having the formula: FeₓN_{y}, wherein x=75-95 at %, and wherein y=5-25 at %.

19. The method of claim 18, wherein the one or more gases introduced into the reactive chamber are selected from the group consisting of: NH₃, O₂, H₂, and CO.

20. The method of claim 19, further comprising the steps of:
when the one or more gases are introduced into the reactive chamber, heating the ferromagnetic particles in a reactive chamber to a temperature of 400-750° C. for 6-24 hours; and
mixing the ferromagnetic particles with the one or more gases introduced into the reactive chamber using metallic balls.
